(19) United States
(12) Patent Application Publication
(10) Pub. No.: US 2026/0244217 A1
(43) Pub. Date: Aug. 20, 2026

(54) PRIORITY REGION CLEANING METHOD AND DEVICE, CLEANING MACHINE, AND STORAGE MEDIUM

(71) Applicant: SHENZHEN HANYANG TECHNOLOGY CO., LTD., Shenzhen (CN)

(72) Inventors: Yang HUANG, Shenzhen (CN); Meiqi YANG, Shenzhen (CN); Yufan CHEN, Shenzhen (CN)

(21) Appl. No.: 19/641,223

(22) Filed: Apr. 7, 2026

Related U.S. Application Data
(63) Continuation of application No. PCT/CN2023/129978, filed on Nov. 6, 2023.

(30) Foreign Application Priority Data
Oct. 8, 2023 (CN) 202311306008.6

(51) Int. Cl. G05D 1/648; E01H 5/09; G05D 1/246; G05D 1/622; G05D 105/10

(52) U.S. Cl. CPC G05D 1/6482; E01H 5/09; G05D 1/2469; G05D 1/622; G05D 1/6486; G05D 2105/10

(57) ABSTRACT

Disclosed are a priority region cleaning method and device, a cleaning machine, and a storage medium. The method includes: when a cleaning machine performs a first cleaning operation on a predefined cleaning region, upon detecting that the cleaning machine triggers a predefined cleaning issue, recording a cleaning region corresponding to the triggered predefined cleaning issue as a priority region; after the first cleaning operation is completed, obtaining a second-pass cleaning sequence by arranging all priority regions recorded during the first cleaning operation in a cleaning order according to a predefined arrangement rule; and controlling the cleaning machine to perform a second cleaning operation on all the priority regions according to the second-pass cleaning sequence.

### CROSS-REFERENCE TO RELATED APPLICATIONS

This patent document claims priority to and benefits of PCT Application No. PCT/CN2023/129978 filed on Nov. 6, 2023, which claims priority to and benefits of Chinese Patent Application No. 202311306008.6 filed on Oct. 8, 2023, both entitled “KEY REGION CLEANING METHOD AND APPARATUS, AND CLEANING MACHINE AND STORAGE MEDIUM,” the entire contents of each of which are incorporated herein by reference.

### TECHNICAL FIELD

The present disclosure relates to the technical field of cleaning, and in particular to a priority region cleaning method and device, a cleaning machine, and a storage medium.

### BACKGROUND

At present, with the gradual development of society, intelligent cleaning machines play an important role in people's lives, such as snow clearing robots, and may effectively reduce human workload and improve work efficiency. The inventors have recognized that during the self-moving operation of some cleaning machines, the boundary shape of a working region is complex and is affected by various obstacles (for example, the working region of a snow clearing robot may be affected by thick snow accumulation or ground protrusions/icicles/ground cracks), which may lead to a complex environment in the working region of the cleaning machine, resulting in the omission of some working regions, reducing the cleaning efficiency of the cleaning machine, and causing adverse effects such as poor user experience. In addition, when some manually operated cleaning machines clean working regions that need priority cleaning, they may only manually determine which regions need priority cleaning, and manual adjustments are needed multiple times to perform the priority cleaning, which results in a low degree of intelligence and is time-consuming.

### SUMMARY

Embodiments of the present application provide a priority region cleaning method and device, a cleaning machine, and a storage medium, so as to address the technical problems existing in prior art cleaning machines of missed cleaning regions, low intelligence level, and excessive time consumption.

A priority region cleaning method includes:
when a cleaning machine performs a first cleaning operation on a predefined cleaning region, upon detecting that the cleaning machine triggers a predefined cleaning issue, recording a cleaning region corresponding to the triggered predefined cleaning issue as a priority region;
obtaining a second-pass cleaning sequence by arranging, after the first cleaning operation is completed, all priority regions recorded during the first cleaning operation in a cleaning order according to a predefined arrangement rule; and
controlling the cleaning machine to perform a second cleaning operation on all the priority regions according to the second-pass cleaning sequence.

A cleaning machine includes a drive component, a cleaning component, and a controller. The controller includes a memory, a processor, and computer-readable instructions stored in the memory and executable on the processor. When executing the computer-readable instructions, the processor controls the drive component and the cleaning component to perform the following steps:
when the cleaning machine performs a first cleaning operation on a predefined cleaning region, upon detecting that the cleaning machine triggers a predefined cleaning issue, recording a cleaning region corresponding to the triggered predefined cleaning issue as a priority region;
obtaining a second-pass cleaning sequence by arranging, after the first cleaning operation is completed, all priority regions recorded during the first cleaning operation in a cleaning order according to a predefined arrangement rule; and
controlling the cleaning machine to perform a second cleaning operation on all the priority regions according to the second-pass cleaning sequence.

A non-transitory computer-readable storage medium stores computer-readable instructions. When the computer-readable instructions are executed by a processor, the processor is caused to perform the following steps:
when a cleaning machine performs a first cleaning operation on a predefined cleaning region, upon detecting that the cleaning machine triggers a predefined cleaning issue, recording a cleaning region corresponding to the triggered predefined cleaning issue as a priority region;
obtaining a second-pass cleaning sequence by arranging, after the first cleaning operation is completed, all priority regions recorded during the first cleaning operation in a cleaning order according to a predefined arrangement rule; and
controlling the cleaning machine to perform a second cleaning operation on all the priority regions according to the second-pass cleaning sequence.

The priority region cleaning method and device, the cleaning machine, and the storage medium provided by the present application operate as follows. The method includes: when a cleaning machine performs a first cleaning operation on a predefined cleaning region, upon detecting that the cleaning machine triggers a predefined cleaning issue, recording a cleaning region corresponding to the triggered predefined cleaning issue as a priority region; obtaining a second-pass cleaning sequence by arranging, after the first cleaning operation is completed, all priority regions recorded during the first cleaning operation in a cleaning order according to a predefined arrangement rule; and controlling the cleaning machine to perform a second cleaning operation on all the priority regions according to the second-pass cleaning sequence.

In the present application, during the first cleaning process, all priority regions corresponding to all predefined cleaning issues triggered within the entire predefined cleaning region are recorded. A second-pass cleaning sequence is then planned based on the recorded priority regions, and a second cleaning operation is subsequently performed on all the priority regions according to the second-pass cleaning sequence. In this way, within the same predefined cleaning region, the present application carries out targeted second-pass cleaning on all the priority regions that trigger the predefined cleaning issue, without any missed cleaning regions, thereby ensuring a cleaning effect on each predefined cleaning region. Furthermore, due to the automatic planning of the second-pass cleaning sequence for all the priority regions, there is no need for manual participation in the planning, which improves the intelligence level of the cleaning process, saves cleaning time, and greatly improves the efficiency of the second-pass cleaning.

Details of one or more embodiments of the present application are provided in the accompanying drawings and descriptions below, and other features and advantages of the present application will become apparent from the specification, the accompanying drawings, and the claims.

### BRIEF DESCRIPTION OF THE DRAWINGS

To more clearly describe the technical solutions in the embodiments of the present application, the following briefly introduces the drawings used in describing the embodiments of the present application. Apparently, the drawings in the following description show only some embodiments of the present application, and those of ordinary skill in the art may also derive other drawings from these drawings without creative effort.

FIG. 1 is a flowchart of a priority region cleaning method in some embodiments of the present disclosure;

FIG. 2 is a flowchart of step S30 of a priority region cleaning method in some embodiments of the present disclosure;

FIG. 3 is a functional block diagram of a priority region cleaning component in some embodiments of the present disclosure;

FIG. 4 is a schematic diagram of working path planning in a priority region cleaning method in some embodiments of the present disclosure; and

FIG. 5 is a schematic diagram of a controller in some embodiments of the present disclosure.

### DETAILED DESCRIPTION

The technical solutions in the embodiments of the present disclosure will be clearly described in the following with reference to the accompanying drawings in the embodiments of the present disclosure. Apparently, the described embodiments are some rather than all of the embodiments of the present disclosure. All other embodiments obtained by those of ordinary skill in the art based on the embodiments of the present disclosure without making creative efforts are considered to fall within the scope of the present disclosure.

The priority region cleaning method provided by the present disclosure may be applied in various application environments, in which a client (computing device) communicates with a server through a network. The client (computing device) includes, but is not limited to, various personal computers, laptop computers, smartphones, tablet computers, cameras, and portable wearable devices. The server may be implemented using an independent server or a server cluster composed of multiple servers. The server and an unmanned inventory device are communicatively connected through wireless signals.

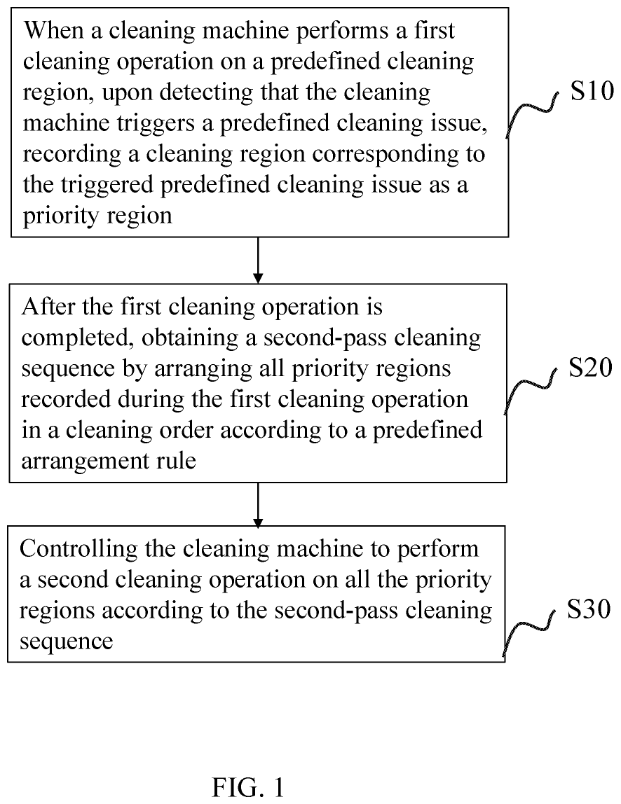

In some embodiments, as shown in FIG. 1, a priority region cleaning method is provided, which may be applied to a cleaning machine, and includes the following steps.

S10: when a cleaning machine performs a first cleaning operation on a predefined cleaning region, upon detecting that the cleaning machine triggers a predefined cleaning issue, recording a cleaning region corresponding to the triggered predefined cleaning issue as a priority region. It is understood that the predefined cleaning issue includes, but is not limited to, an obstacle issue, a thick snow accumulation issue, a slip issue (including a repeated slip issue), a poor network issue, and the like. The obstacle issue refers to an obstacle-related issue encountered by the cleaning machine, such as encountering a movable obstacle (such as a moving vehicle, an animal, or an object that may be moved by a person). At this point, after the cleaning machine bypasses the movable obstacle, the obstacle subsequently continues to be moved, and the region previously covered by the obstacle has not been cleaned. Therefore, the cleaning region covered by the movable obstacle needs to be recorded as a priority region. The thick snow accumulation issue and some other predefined cleaning issues (such as a position point where the cleaning machine escapes after becoming stuck) may also trigger a slip issue. Therefore, the specific predefined cleaning issues may be determined according to actual needs. A slip may refer to a state where a positioning sensor and a Real-Time Kinematic (RTK) module of the cleaning machine determine that the position of the cleaning machine has not moved, while the wheels have actually moved. For example, when a snow clearing robot (cleaning machine) encounters ground protrusions, icicles, or ground cracks during a snow clearing process and moves onto a snow pile, the positioning sensor of the snow clearing robot determines that the position of the snow clearing robot has not changed, but detects that the wheels of the snow clearing robot have moved, in which case it may be determined that a slip issue exists. The predefined cleaning region refers to a pre-divided region that needs to be cleaned by the cleaning machine, and its specific size may be set according to actual needs.

In some embodiments, step S10, that is, recording, upon detecting that the predefined cleaning issue is triggered, the cleaning region corresponding to the triggered predefined cleaning issue as the priority region, includes:
acquiring real-time position change information of the cleaning machine in an electronic map corresponding to the predefined cleaning region, and cleaning motion information of the cleaning machine during the first cleaning operation. Specifically, in some embodiments, each predefined cleaning region is marked in the electronic map, and the real-time position change information of the cleaning machine in the predefined cleaning region may be fed back and displayed in the electronic map. It is understood that fixed obstacles may be marked in the electronic map. Therefore, obstacles other than the fixed obstacles may be considered as movable obstacles. The marking information for the fixed obstacles may also be considered as part of the real-time position change information. Alternatively, after identifying an obstacle through a sensor of the cleaning machine, the position information of the obstacle in the electronic map is determined as the real-time position change information. The sensors used for identification include, but are not limited to, visual sensors, millimeter wave radar, and LiDAR (Light Detection and Ranging). During the cleaning process of a predefined cleaning region, the cleaning machine records the corresponding cleaning motion information. For example, the cleaning motion information may include whether the wheels of the cleaning machine are moving, the speed and acceleration of the motion, the inclination angle of the vehicle body, and the motion states of various structural components of the cleaning machine during the first cleaning operation.

Upon determining, based on the real-time position change information and the cleaning motion information, that the cleaning machine triggers the predefined cleaning issue, the priority region corresponding to the triggered predefined cleaning issue is identified and marked in the electronic map. In this step, whether the cleaning machine triggers the predefined cleaning issue in the current cleaning region may be determined based on the real-time position change information and the cleaning motion information. Upon determining that the predefined cleaning issue is triggered, the predefined cleaning issue and the priority region corresponding to the triggered predefined cleaning issue are associatively stored, and the priority region is marked in the electronic map for subsequent operations.

S20: after the first cleaning operation is completed, a second-pass cleaning sequence is obtained by arranging all priority regions recorded during the first cleaning operation in a cleaning order according to a predefined arrangement rule. Here, the predefined arrangement rule refers to the arrangement of the cleaning order for all the priority regions to obtain the second-pass cleaning sequence for cleaning all the priority regions.

S30: the cleaning machine is controlled to perform a second cleaning operation on all the priority regions according to the second-pass cleaning sequence. In other words, after the second-pass cleaning sequence is determined, an optimal working path may be determined according to the second-pass cleaning sequence, and the second cleaning operation is then performed according to the working path.

The priority region cleaning method of the present disclosure records, during the first cleaning process, all priority regions corresponding to all predefined cleaning issues triggered within the entire predefined cleaning region, plans a second-pass cleaning sequence based on the recorded priority regions, and then performs the second cleaning operation on all the priority regions according to the second-pass cleaning sequence. In this way, within the same predefined cleaning region, the present disclosure carries out targeted second-pass cleaning on all the priority regions that trigger the predefined cleaning issue, without any missed cleaning regions, thereby ensuring a cleaning effect on each predefined cleaning region. Furthermore, due to the automatic planning of the second-pass cleaning sequence for all the priority regions, there is no need for manual participation in the planning, which improves the intelligence level of the cleaning process, saves cleaning time, and greatly improves the efficiency of the second-pass cleaning.

It should be noted that the priority regions mentioned above may be one or more. The second-pass cleaning operation represents one possible implementation, and in other embodiments, multiple cleaning operations may be set to achieve a higher cleaning effect. Therefore, the number of cleaning operations is not limited.

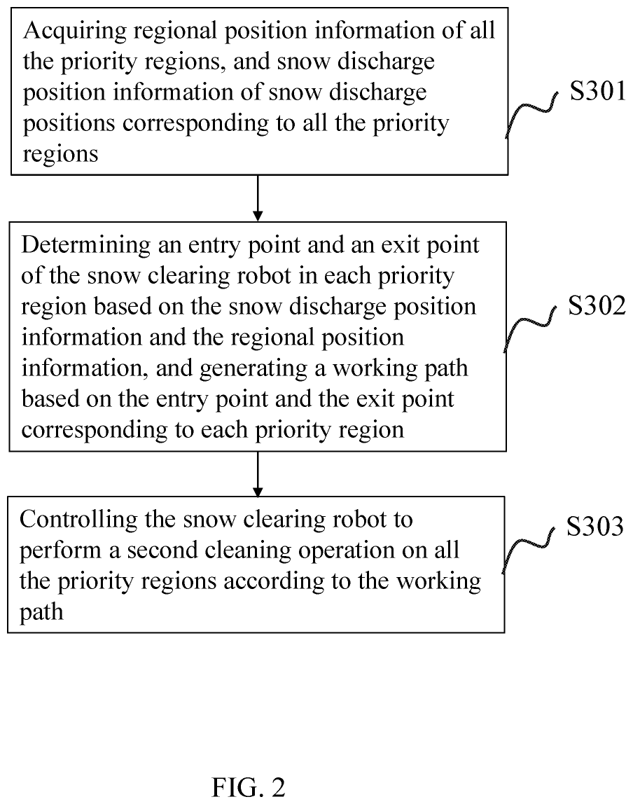

In some embodiments, as shown in FIG. 2, the cleaning machine may be a snow clearing robot. At this point, when each priority region is cleaned, the cleared snow needs to be deposited at a snow discharge position. The snow discharge position refers to a position region specifically set for the predefined cleaning region where the cleared snow is to be deposited. Additionally, step S30, that is, controlling the cleaning machine to perform the second cleaning operation on all the priority regions according to the second-pass cleaning sequence, includes the following steps.

S301: regional position information of all the priority regions, and snow discharge position information of snow discharge positions corresponding to all the priority regions are acquired. Here, the regional position information refers to position coordinates, shape, area, and other information corresponding to each priority region. The snow discharge position information refers to position coordinates, shape, area, and other information corresponding to the snow discharge position.

S302: an entry point and an exit point of the snow clearing robot in each priority region are determined based on the snow discharge position information and the regional position information, and a working path is generated based on the entry point and the exit point corresponding to each priority region. In some embodiments, in the process of planning the working path, it is beneficial to generate the working path based on the regional position information of each priority region and the snow discharge position information, so that the generated working path is an optimal working path, avoiding the snow clearing robot traveling through excessive ineffective paths.

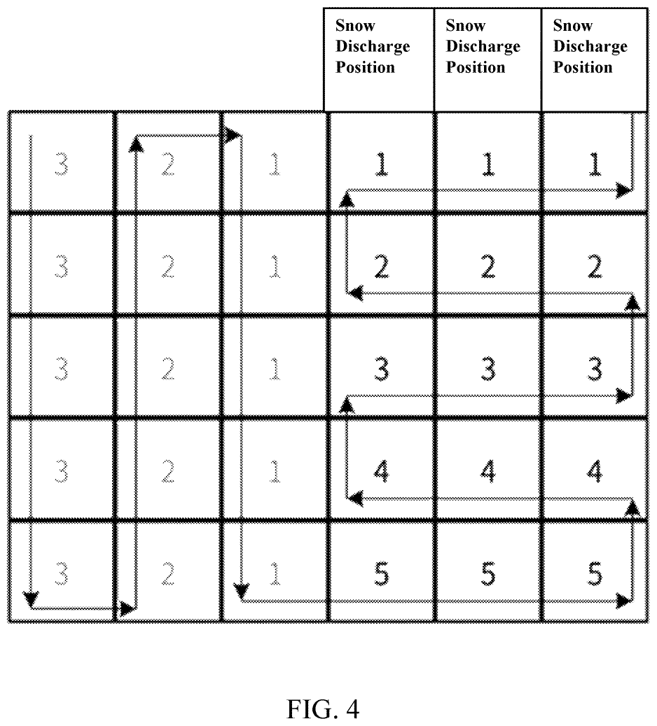

S303: the snow clearing robot is controlled to perform the second cleaning operation on all the priority regions according to the working path. In other words, after the working path is determined, the snow clearing robot then performs the second cleaning operation according to the working path. It should be noted that when planning the working path, it is desirable to maintain path continuity between the entry and exit points of one priority region and those of the previous and next adjacent priority regions (that is, an end point of the previous priority region preferably coincides with a start point of the next priority region) to form a shorter overall path. In addition, if one priority region is too large, a traveling direction for “S” shaped or zigzag pattern cleaning of the working path (as illustrated in FIG. 4) in that priority region may be determined based on the above path continuity consideration, so that during the “S” shaped or zigzag pattern cleaning performed by the snow clearing robot, the exit point of the current priority region may maintain path continuity with the entry point of the next adjacent priority region.

Additionally, generating the working path based on the entry point and the exit point corresponding to each priority region also includes:
acquiring a positional relationship between each priority region and the snow discharge position; and
generating the working path based on the positional relationship and the entry point and the exit point corresponding to each priority region. Specifically, since the snow clearing robot performs snow discharge operations according to the level of potential energy, the level of potential energy refers to the distance between the snow clearing robot and the snow discharge position (the greater the distance, the greater the potential energy for snow discharge) and the direction (the more the direction of the snow clearing robot deviates from the snow discharge position, the greater the potential energy for snow discharge). In other words, it is desirable to perform snow discharge operations from regions with higher potential energy toward regions with lower potential energy. When there are multiple priority regions, the snow may first be discharged from one priority region to another before being discharged from the last priority region to the snow discharge position. In this process, it is advisable to assess the relationship between the priority region and the snow discharge position. If the priority region is far from the snow discharge position, the snow clearing robot is controlled to travel to a position in the priority region close to the snow discharge position (where the snow clearing robot stays in the priority region and performs snow discharge), and the snow clearing robot is controlled to perform snow discharge from that position toward the snow discharge position. If the priority region is close to the snow discharge position, the snow clearing robot is controlled to perform snow discharge directly from the priority region toward the snow discharge position.

In some embodiments, in step S302, determining the entry point and the exit point of the snow clearing robot in each priority region based on the snow discharge position information and the regional position information includes:
acquiring position information of a charging station corresponding to the snow clearing robot; and
determining the entry point and the exit point of the snow clearing robot in each priority region based on the position information of the charging station, the snow discharge position information, and the regional position information.

It is understood that in some embodiments, if the charging station serves as the starting point and/or the end point for the second cleaning operation of the snow clearing robot, the position information of the charging station may be taken into account as the starting point and/or the end point in the process of planning the working path. The optimal working path may then be generated by referring to the regional position information of each priority region and the snow discharge position information of the snow discharge position, thereby avoiding the snow clearing robot traveling through excessive ineffective paths. It is understood that the charging station may not serve as the starting point or the end point for the second cleaning operation. In this case, according to the above embodiments, the entry point and the exit point of the snow clearing robot in each priority region may be determined based solely on the snow discharge position information and the regional position information.

In some embodiments, step S303, that is, controlling the snow clearing robot to perform the second cleaning operation on all the priority regions according to the working path, includes:
controlling the snow clearing robot to start advancing toward a starting point of the working path, and, before the snow clearing robot reaches the starting point, detecting in real time whether a region currently being traversed meets a predefined snow clearing condition. In some embodiments, since the current environment may still be snowing (or may have just snowed), other cleaning regions following the previous first cleaning operation may be covered by snow again. At this point, the snow clearing robot activates a snow clearing function upon determining that the predefined snow clearing condition is met, and continues to clean the region currently being traversed, that is, performs a first snow discharge operation. The predefined snow clearing condition may be set according to actual needs. For example, if there is too much snow or ice on the road surface in the region currently being traversed, or if it is currently snowing, the region currently being traversed may be considered as meeting the predefined snow clearing condition.

The above real-time detection may be performed through a detection module of the snow clearing robot. The detection module includes, but is not limited to, a communication module, a visual sensor, a LiDAR, an Inertial Measurement Unit (IMU) sensor, or a wheel speed sensor. The visual sensor may directly perform image recognition based on captured road surface images of the region currently being traversed, determine the ice and snow state on the road surface, and upon determining that there is too much snow on the road surface, confirm that the region currently being traversed meets the predefined snow clearing condition. The IMU sensor and the LiDAR may both determine road surface smoothness information in the region currently being traversed. After acquiring the current road slope angle from the motion information of the snow clearing robot, upon determining that there is a significant difference between the current road slope angle and the road surface smoothness information, it may be determined that there is too much snow on the current road surface, and the region currently being traversed may also be confirmed as meeting the predefined snow clearing condition. The wheel speed sensor may measure wheel rotation information. In snow or ice scenarios, if the wheel rotation information indicates that the wheels are rotating, but the current motion information of the snow clearing robot indicates that the position of the snow clearing robot has not changed significantly, the region currently being traversed may also be confirmed as meeting the predefined snow clearing condition.

Additionally, whether the region currently being traversed meets the predefined snow clearing condition may also be detected in real time based on real-time weather information corresponding to the region currently being traversed. This real-time weather information may be acquired through a communication module installed on the snow clearing robot. That is, when the real-time weather information acquired by the communication module indicates that it is currently snowing (or snowing heavily), it is confirmed that the region currently being traversed meets the predefined snow clearing condition.

Upon detecting that the region currently being traversed meets the predefined snow clearing condition, the snow clearing robot is controlled to activate the snow auger motor and perform a first snow discharge operation on the region currently being traversed. In other words, upon determining that the region currently being traversed meets the predefined snow clearing condition, the snow auger motor is activated and the first snow discharge operation is performed to promptly clear the ice and snow on the road surface. It should be noted that if the snow clearing robot keeps the snow auger motor activated for snow clearing in all regions it currently passes through, the snow clearing robot consumes more electrical energy in some regions that do not need snow clearing. Therefore, in some embodiments, the first snow discharge operation is performed after the predefined snow clearing condition is assessed, which saves electrical energy while ensuring the cleaning effect.

It should be noted that the snow auger motor corresponds to a snow clearing bucket in the snow clearing robot, and the snow clearing bucket is provided with snow auger blades. The snow clearing bucket and the snow auger motor may both be referred to as a cleaning component.

In some embodiments, the cleaning machine may be a snow clearing robot, and the predefined cleaning issue may include a thick snow accumulation issue. The thick snow accumulation issue may refer to snow accumulation exceeding a certain thickness, which makes it impractical for the snow clearing robot to clear all the snow at once, making layer-by-layer clearing practical.

Additionally, step S10, that is, recording, upon detecting that the cleaning machine triggers the predefined cleaning issue, the cleaning region corresponding to the triggered predefined cleaning issue as the priority region, includes:
upon detecting that the cleaning machine triggers the thick snow accumulation issue, controlling the cleaning machine to perform a second snow discharge operation to remove at least a portion of the snow accumulation in the cleaning region corresponding to the thick snow accumulation issue, and recording the cleaning region after removal of the portion of the snow accumulation as a priority region. It is understood that in some embodiments, upon determining that the thick snow accumulation issue is triggered, the snow accumulation may be too thick, and addressing the region solely through the second cleaning operation may be time-consuming and difficult. Therefore, the priority region corresponding to the thick snow accumulation issue may be cleaned in two passes. That is, the upper portion of the thick snow accumulation may be cleared during the first cleaning operation (the specific clearing thickness or proportion may be set according to actual needs), and the remaining portion is removed during the second cleaning operation after being recorded as a priority region. It is understood that in the present disclosure, for the priority region corresponding to the thick snow accumulation issue, it is also possible to perform no clearing during the first cleaning operation and leave all clearing to be completed during the second cleaning operation. It is understood that when cleaning the priority region corresponding to the thick snow accumulation issue, multiple snow clearing passes may be needed during each cleaning operation (such as the first cleaning operation or the second cleaning operation). After lifting or lowering the snow clearing bucket of the snow clearing robot during each clearing pass, the snow clearing robot may be controlled to first retreat a first predefined distance and then advance a second predefined distance (the second predefined distance is greater than the first predefined distance), so that the snow accumulation is cleared in stages.

In some embodiments, the predefined cleaning issue may include a repeated slip issue. The repeated slip issue refers to a situation in step S10 where the multiple predefined cleaning issues continuously detected as triggered by the cleaning machine are all slip issues.

Additionally, step S10, that is, recording, upon detecting that the cleaning machine triggers the predefined cleaning issue, the cleaning region corresponding to the triggered predefined cleaning issue as the priority region, includes:
upon detecting that the cleaning machine triggers the repeated slip issue (which may occur at different time points that are proximate to one another), determining a slip start point and a slip end point corresponding to the repeated slip issue, recording a slip path between the slip start point and the slip end point as a first region length, and recording a first predefined multiple of a width of the cleaning machine as a first region width. The slip start point refers to a position point corresponding to the slip issue triggered for the first time among the continuously detected triggered slip issues, while the slip end point refers to a position point corresponding to the slip issue triggered for the last time among the continuously detected triggered slip issues. The first region length may refer to a line connecting the slip start point and the slip end point along a straight line or curve. The first region length may pass through the position points corresponding to all the slip issues detected across the multiple occurrences. The width of the cleaning machine may refer to the maximum body width of the cleaning machine, and the first predefined multiple may be set according to actual needs, such as one maximum body width or half of the maximum body width.

A cleaning region corresponding to the repeated slip issue and generated based on the first region length and the first region width is recorded as a priority region. In other words, the width of the slip path may be expanded to the first region width in the extending direction of the first region length, and the corresponding area region is recorded as a priority region.

In some embodiments, the predefined cleaning issue may include an obstacle issue. The obstacle issue refers to an obstacle-related issue encountered by the cleaning machine, and upon encountering an obstacle, the cleaning machine avoids the obstacle to continue cleaning.

Additionally, step S10, that is, recording, upon detecting that the cleaning machine triggers the predefined cleaning issue, the cleaning region corresponding to the triggered predefined cleaning issue as the priority region, includes:
upon detecting that the cleaning machine triggers the obstacle issue, determining whether other adjacent obstacle regions exist within a predefined range surrounding the cleaning region corresponding to the obstacle issue, where the other adjacent obstacle regions refer to other priority regions that have already been identified as corresponding to other obstacle issues; and
upon determining that other adjacent obstacle regions exist, merging and recording the identified other adjacent obstacle regions and the cleaning region corresponding to the obstacle issue as a new priority region.

In some embodiments, if there are multiple other adjacent obstacle regions corresponding to other obstacle issues around the cleaning region corresponding to the obstacle issue within a predefined range (the predefined range may be set according to actual needs, and may be an area range that includes the cleaning region corresponding to the obstacle issue and extends outward along the boundary of the cleaning region by a certain width), the cleaning region may be combined and merged with the other obstacle regions to form a larger new priority region, so as to simplify the workload of working path planning. The larger area also makes obstacle avoidance maneuvers easier to execute.

In some embodiments, the predefined cleaning issue may include a poor network issue. The poor network issue refers to a situation where there is an absence of network signal or a relatively high number of network disconnections within a short period of time (within a predefined duration).

Additionally, step S10, that is, recording, upon detecting that the cleaning machine triggers the predefined cleaning issue, the cleaning region corresponding to the triggered predefined cleaning issue as the priority region, includes:
upon detecting that the cleaning machine triggers the poor network issue, determining a poor signal start point and a signal recovery start point corresponding to the poor network issue, recording a travel path between the poor signal start point and the signal recovery start point as a second region length, and recording a second predefined multiple of a width of the cleaning machine as a second region width. The poor signal start point refers to a position point corresponding to the time point when the network starts to be disconnected (or the starting time of intermittent network connectivity within a predefined duration). The signal recovery start point refers to a position point corresponding to the starting time point when the signal returns to normal (and remains normal within the predefined duration thereafter). The second region length may refer to a line connecting the poor signal start point and the signal recovery start point along a straight line or curve. The second region length may pass through some or all of the position points actually traversed by the snow clearing robot during the time period between the poor signal start point and the signal recovery start point. The width of the cleaning machine may refer to the maximum body width of the cleaning machine, and the second predefined multiple may be set according to actual needs, such as one maximum body width or half of the maximum body width. The second predefined multiple may be the same as or different from the first predefined multiple.

A cleaning region corresponding to the poor network issue and generated based on the second region length and the second region width is recorded as a priority region. In other words, the width of the travel path may be expanded to the second region width in the extending direction of the second region length, and the corresponding area region is recorded as a priority region.

It should be understood that in the above embodiments, the sequence numbers assigned to the steps above do not indicate the order in which they are to be executed. The execution order of each process is to be determined according to its function and inherent logic, and does not impose any limitation on the implementation of the embodiments of the present disclosure.

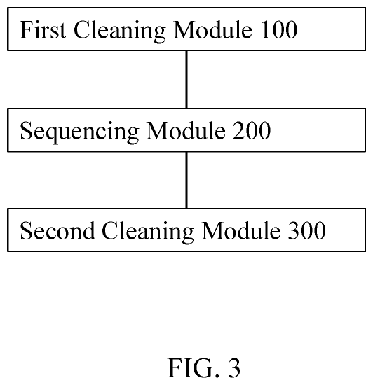

In some embodiments, as shown in FIG. 3, a priority region cleaning machine is provided. The priority region cleaning machine corresponds one-to-one with the priority region cleaning method described in the above embodiments. The priority region cleaning machine includes:
a first cleaning module 100, configured to record, when a cleaning machine performs a first cleaning operation on a predefined cleaning region, upon detecting that the cleaning machine triggers a predefined cleaning issue, a cleaning region corresponding to the triggered predefined cleaning issue as a priority region;
a sequencing module 200, configured to obtain a second-pass cleaning sequence by arranging, after the first cleaning operation is completed, all priority regions recorded during the first cleaning operation in a cleaning order according to a predefined arrangement rule; and
a second cleaning module 300, configured to control the cleaning machine to perform a second cleaning operation on all the priority regions according to the second-pass cleaning sequence.

The priority region cleaning device of the present disclosure records, during the first cleaning process, all priority regions corresponding to all predefined cleaning issues triggered within the entire predefined cleaning region, plans a second-pass cleaning sequence based on the recorded priority regions, and then performs the second cleaning operation on all the priority regions again according to the second-pass cleaning sequence. In this way, within the same predefined cleaning region, the present disclosure carries out targeted second-pass cleaning on all the priority regions that trigger the predefined cleaning issue, without any missed cleaning regions, thereby ensuring a cleaning effect on each predefined cleaning region. Furthermore, due to the automatic planning of the second-pass cleaning sequence for all the priority regions, there is no need for manual participation in the planning, which improves the intelligence level of the cleaning process, saves cleaning time, and greatly improves the efficiency of the second-pass cleaning.

For further details regarding the priority region cleaning machine, reference may be made to the description of the priority region cleaning method above, which will not be repeated here. The modules of the above priority region cleaning machine may be implemented fully or partially through software, hardware, or a combination thereof. The above modules may be embedded in or implemented independently of a processor of a computing device in hardware form, or stored in a memory of the computing device in software form, so that the processor may invoke and execute the operations corresponding to each of the above modules.

In some embodiments, a cleaning machine is provided, including a drive component, a cleaning component, and a controller. The controller includes a memory, a processor, and computer-readable instructions stored in the memory and executable on the processor. When executing the computer-readable instructions, the processor controls the drive component and the cleaning component to perform the following steps:
when the cleaning machine performs a first cleaning operation on a predefined cleaning region, upon detecting that the cleaning machine triggers a predefined cleaning issue, recording a cleaning region corresponding to the triggered predefined cleaning issue as a priority region;
obtaining a second-pass cleaning sequence by arranging, after the first cleaning operation is completed, all priority regions recorded during the first cleaning operation in a cleaning order according to a predefined arrangement rule; and
controlling the cleaning machine to perform a second cleaning operation on all the priority regions according to the second-pass cleaning sequence.

In some embodiments, recording, upon detecting that the cleaning machine triggers the predefined cleaning issue, the cleaning region corresponding to the triggered predefined cleaning issue as the priority region, includes:
acquiring real-time position change information of the cleaning machine in an electronic map corresponding to the predefined cleaning region, and cleaning motion information of the cleaning machine during the first cleaning operation; and
upon determining, based on the real-time position change information and the cleaning motion information, that the cleaning machine triggers the predefined cleaning issue, identifying the priority region corresponding to the triggered predefined cleaning issue and marking the priority region in the electronic map.

In some embodiments, the cleaning machine may be a snow clearing robot, and controlling the cleaning machine to perform the second cleaning operation on all the priority regions according to the second-pass cleaning sequence includes:
acquiring regional position information of all the priority regions, and snow discharge position information of snow discharge positions corresponding to all the priority regions;
determining an entry point and an exit point of the snow clearing robot in each priority region based on the snow discharge position information and the regional position information, and generating a working path based on the entry point and the exit point corresponding to each priority region; and
controlling the snow clearing robot to perform the second cleaning operation on all the priority regions according to the working path.

In some embodiments, determining the entry point and the exit point of the snow clearing robot in each priority region based on the snow discharge position information and the regional position information includes:
acquiring position information of a charging station corresponding to the snow clearing robot; and
determining the entry point and the exit point of the snow clearing robot in each priority region based on the position information of the charging station, the snow discharge position information, and the regional position information.

In some embodiments, controlling the snow clearing robot to perform the second cleaning operation on all the priority regions according to the working path includes:
controlling the snow clearing robot to start advancing toward a starting point of the working path, and, before the snow clearing robot reaches the starting point, detecting in real time whether a region currently being traversed meets a predefined snow clearing condition; and
upon detecting that the region currently being traversed meets the predefined snow clearing condition, controlling the snow clearing robot to activate the snow auger motor and perform a first snow discharge operation on the region currently being traversed.

In some embodiments, the cleaning machine may be a snow clearing robot, and the predefined cleaning issue may include a thick snow accumulation issue.

Recording, upon detecting that the cleaning machine triggers the predefined cleaning issue, the cleaning region corresponding to the triggered predefined cleaning issue as the priority region, includes:
upon detecting that the cleaning machine triggers the thick snow accumulation issue, controlling the cleaning machine to perform a second snow discharge operation to remove at least a portion of the snow accumulation in the cleaning region corresponding to the thick snow accumulation issue, and recording the cleaning region after removal of the portion of the snow accumulation as a priority region.

In some embodiments, the predefined cleaning issue may include a repeated slip issue.

Recording, upon detecting that the cleaning machine triggers the predefined cleaning issue, the cleaning region corresponding to the triggered predefined cleaning issue as the priority region, includes:
upon detecting that the cleaning machine triggers the repeated slip issue, determining a slip start point and a slip end point corresponding to the repeated slip issue, recording a slip path between the slip start point and the slip end point as a first region length, and recording a first predefined multiple of a width of the cleaning machine as a first region width; and
recording a cleaning region corresponding to the repeated slip issue and generated based on the first region length and the first region width as a priority region.

In some embodiments, the predefined cleaning issue may include an obstacle issue.

Recording, upon detecting that the cleaning machine triggers the predefined cleaning issue, the cleaning region corresponding to the triggered predefined cleaning issue as the priority region, includes:
upon detecting that the cleaning machine triggers the obstacle issue, determining whether other adjacent obstacle regions exist within a predefined range surrounding the cleaning region corresponding to the obstacle issue, where the other adjacent obstacle regions refer to other priority regions that have already been identified as corresponding to other obstacle issues; and
upon determining that other adjacent obstacle regions exist, merging and recording the identified other adjacent obstacle regions and the cleaning region corresponding to the obstacle issue as a new priority region.

In some embodiments, the predefined cleaning issue may include a poor network issue.

Recording, upon detecting that the cleaning machine triggers the predefined cleaning issue, the cleaning region corresponding to the triggered predefined cleaning issue as the priority region, includes:
upon detecting that the cleaning machine triggers the poor network issue, determining a signal degradation start point and a signal recovery start point corresponding to the poor network issue, recording a travel path between the signal degradation start point and the signal recovery start point as a second region length, and recording a second predefined multiple of a width of the cleaning machine as a second region width; and
recording a cleaning region corresponding to the poor network issue and generated based on the second region length and the second region width as a priority region.

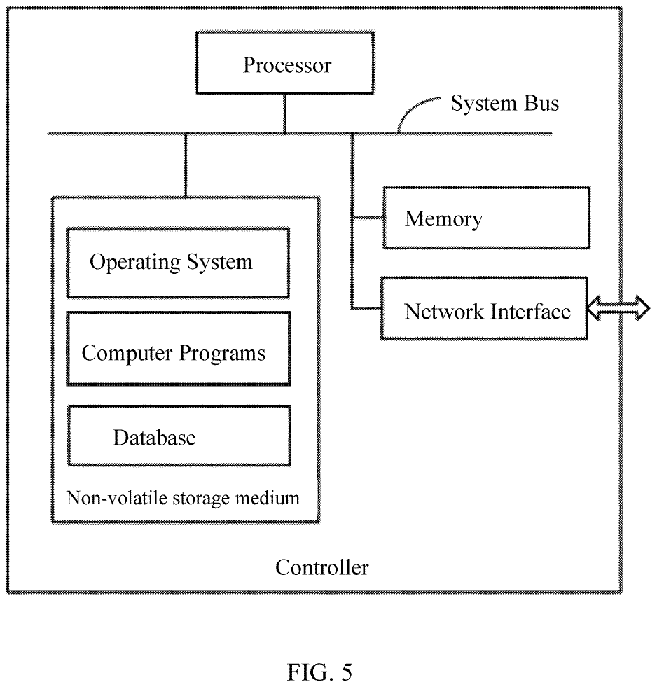

The internal structure of the above controller may be as shown in FIG. 5. The controller includes a processor, a memory, a network interface, and a database connected through a system bus. The processor of the controller is configured to provide computing and control capabilities. The memory of the controller includes a non-volatile storage medium and an internal memory. The non-volatile storage medium stores an operating system, computer-readable instructions, and a database. The internal memory provides an operating environment for the operating system and the computer-readable instructions stored in the non-volatile storage medium. When the computer-readable instructions are executed by the processor, the processor is caused to perform the steps of the above priority region cleaning method.

For further details regarding the controller, reference may be made to the description of the priority region cleaning method above, which will not be repeated here. The modules of the above controller may be implemented fully or partially through software, hardware, or a combination thereof. The above modules may be embedded in or implemented independently of the processor of the controller in hardware form, or stored in the memory of the controller in software form, so that the processor may invoke and execute the operations corresponding to each of the above modules.

In some embodiments, one or more non-transitory computer-readable storage media storing computer-readable instructions are provided. The non-transitory computer-readable storage media provided in these embodiments include non-volatile readable storage media and volatile readable storage media. The computer-readable instructions, when executed by one or more processors, cause the one or more processors to perform the steps of the above priority region cleaning method.

Those of ordinary skill in the art will appreciate that all or some of the procedures of the method in the above embodiments may be performed by computer-readable instructions directing the relevant hardware. The computer-readable instructions may be stored in a non-volatile computer-readable storage medium or a volatile readable storage medium. When executed, the computer-readable instructions may encompass the procedures of the embodiments of the above method. Any reference to the memory, the storage, the database, or other media used in the embodiments of the present disclosure may include non-volatile and/or volatile memory. The non-volatile memory may include a read-only memory (ROM), a programmable ROM (PROM), an electrically programmable ROM (EPROM), an electrically erasable programmable ROM (EEPROM), or a flash memory. The volatile memory may include a random access memory (RAM) or an external cache memory. By way of illustration, RAM may be available in various forms, such as a static RAM (SRAM), a dynamic RAM (DRAM), a synchronous DRAM (SDRAM), a double data rate SDRAM (DDR SDRAM), an enhanced SDRAM (ESDRAM), a synchronous link DRAM (SLDRAM), a rambus direct RAM (RDRAM), a direct rambus dynamic RAM (DRDRAM), and a rambus dynamic RAM (RDRAM).

Those of ordinary skill in the art will appreciate that, for the sake of clarity and conciseness, only the division of the above functional units or modules has been given by way of example. In practical applications, the above functions may be assigned to different functional units or modules according to actual needs, that is, the internal structure of the device may be divided into different functional units or modules to perform all or some of the functions described above.

The above embodiments are intended to illustrate the technical solutions of the present disclosure and not to limit them. Although the present disclosure has been described in detail with reference to the above embodiments, those of ordinary skill in the art will appreciate that the technical solutions described in the above embodiments may still be modified, or some of the technical features thereof may be equivalently substituted. However, these modifications or substitutions do not cause the essential nature of the corresponding technical solutions to depart from the spirit and scope of the technical solutions of the embodiments of the present disclosure, and are considered to fall within the scope of the present disclosure.

1-20. (canceled)

21. A method for operating a cleaning robot, the method comprising:
executing, via a controller of the cleaning robot, a first cleaning operation within a predefined geographical area;
dynamically obtaining, via one or more sensors of the cleaning robot during the first cleaning operation, position data indicating a real-time geographic position of the cleaning robot on an electronic map corresponding to the predefined geographical area, and operational data indicating at least one of a real-time operation state of the cleaning robot or a real-time environmental condition encountered by the cleaning robot during the first cleaning operation;
detecting a predefined trigger condition during the first cleaning operation based on the operational data;
recording, in a memory of the controller, spatial coordinate data defining a priority region on the electronic map based on the position data at a moment the predefined trigger condition is detected, wherein the priority region corresponds to an area associated with the detected predefined trigger condition;
determining a second-pass route for the priority region based on the spatial coordinate data of the priority region; and
controlling the cleaning robot to perform a second cleaning operation on the priority region according to the second-pass route.

22. The method of claim 21, wherein a plurality of priority regions are recorded during the first cleaning operation, the method comprising:
determining a second-pass sequence by arranging the plurality of priority regions in an order according to a predefined arrangement rule based on the spatial coordinate data of each of the plurality of priority regions;
determining the second-pass route based on the second-pass sequence; and
controlling the cleaning robot to perform the second cleaning operation on the plurality of priority regions according to the second-pass route.

23. The method of claim 22, wherein arranging the plurality of priority regions comprises determining, for each of the plurality of priority regions, an entry point and an exit point based on spatial coordinate data of the priority regions and spatial coordinate data of a designated discharge location, the second-pass sequence including the entry point and the exit point of each of the plurality of priority regions.

24. The method of claim 23, comprising obtaining spatial coordinate data of a charging station, wherein the entry point and the exit point for each of the plurality of priority regions are determined based further on a geometric spatial relationship among the plurality of priority regions, the designated discharge location, and the charging station.

25. The method of claim 23, wherein:
the cleaning robot comprises a snow clearing robot;
the designated discharge location comprises a snow discharge position; and
the method comprises:
acquiring snow discharge position information of the snow discharge position; and
determining the second-pass route based further on a geometric spatial relationship between the spatial coordinate data of the priority region and the snow discharge position information.

26. The method of claim 25, wherein controlling the cleaning robot to perform the second cleaning operation comprises:
navigating the snow clearing robot toward a starting point of the second-pass route;
dynamically detecting, prior to reaching the starting point, whether a region currently being traversed meets a predefined snow clearing condition based on at least one of image recognition data from a visual sensor, surface profile data from a LiDAR sensor, wheel rotation data from a wheel speed sensor, or real-time weather data from a communication module; and
activating a snow auger motor to perform a snow discharge operation on the region currently being traversed upon detecting that the region currently being traversed meets the predefined snow clearing condition.

27. The method of claim 22, wherein arranging the plurality of priority regions comprises:
determining, for each of the plurality of priority regions, an entry point and an exit point based on at least one of a distance between the cleaning robot and a designated discharge location or a directional deviation of the cleaning robot relative to the designated discharge location; and
arranging the plurality of priority regions in an order based on the entry points and exit points of the plurality of priority regions.

28. The method of claim 21, wherein the second-pass route for the priority region is determined based further on at least one of a type of the detected predefined trigger condition or a current position of the cleaning robot.

29. The method of claim 21, wherein the predefined trigger condition comprises at least one of:
a slip condition relating to a discrepancy between a rotation of a drive wheel of the cleaning robot and a temporally corresponding change in the geographic position of the cleaning robot within a predefined time period;
an obstacle condition relating to presence of an obstacle that prevents complete coverage of an area during the first cleaning operation;
an accumulation condition relating to an accumulation depth, relative to a threshold depth, of a material accumulated and to be removed; or
a poor network condition relating to a network signal of the cleaning robot relative to a predefined signal strength threshold.

30. The method of claim 29, wherein the predefined trigger condition comprises the slip condition, and recording the spatial coordinate data comprises:
recording a slip start coordinate corresponding to the real-time geographic position of the cleaning robot at a first occurrence of the slip condition and a slip end coordinate corresponding to the real-time geographic position of the cleaning robot at a last occurrence of the slip condition; and
generating the priority region by expanding a slip path vector defined by the slip start coordinate and the slip end coordinate based on a width of the cleaning robot.

31. The method of claim 29, wherein the predefined trigger condition comprises the obstacle condition, and recording the spatial coordinate data comprises:
determining whether a cleaning region corresponding to a detected obstacle condition is within a predefined proximity of a previously recorded priority region on the electronic map; and
when the cleaning region corresponding to the obstacle condition is within the predefined proximity of the previously recorded priority region, generating the priority region by merging the cleaning region corresponding to the obstacle condition with the previously recorded priority region into a single combined priority region.

32. The method of claim 29, wherein the predefined trigger condition comprises the poor network condition, and recording the spatial coordinate data comprises:
recording a poor signal start coordinate corresponding to the real-time geographic position of the cleaning robot at a moment the network signal falls below the predefined threshold, and a signal recovery start coordinate corresponding to the real-time geographic position of the cleaning robot at a moment the network signal recovers above the predefined threshold; and
generating the priority region by expanding a signal loss path vector defined by the poor signal start coordinate and the signal recovery start coordinate based on a physical width of the cleaning robot.

33. The method of claim 29, wherein the predefined trigger condition comprises the accumulation condition, the method comprising:
performing a partial clearance operation on a cleaning area corresponding to the accumulation condition to remove at least a portion of the accumulation during the first cleaning operation prior to recording the spatial coordinate data, wherein the priority region corresponds to the cleaning area following the partial clearance operation.

34. The method of claim 21, comprising:
marking the priority region on the electronic map in association with a type of the detected predefined trigger condition; and
storing, in the memory, an association between the spatial coordinate data of the priority region and the type of the detected predefined trigger condition.

35. A cleaning robot, comprising a drive assembly, a cleaning device, and a controller, wherein the controller comprises a memory, a processor, and computer-readable instructions stored in the memory and executable on the processor, and wherein the processor, when executing the computer-readable instructions, controls the drive assembly and the cleaning device to perform operations including:
executing a first cleaning operation within a predefined geographical area;
dynamically obtaining, via one or more sensors of the cleaning robot during the first cleaning operation, position data indicating a real-time geographic position of the cleaning robot on an electronic map corresponding to the predefined geographical area, and operational data indicating at least one of a real-time operation state of the cleaning robot or a real-time environmental condition encountered by the cleaning robot during the first cleaning operation;
detecting a predefined trigger condition during the first cleaning operation based on the operational data;
recording, in the memory, spatial coordinate data defining a priority region on the electronic map based on the position data at a moment the predefined trigger condition is detected, wherein the priority region corresponds to an area associated with the detected predefined trigger condition;
determining a second-pass route for the priority region based on the spatial coordinate data of the priority region; and
controlling the drive assembly and the cleaning device to perform a second cleaning operation on the priority region according to the second-pass route.

36. The cleaning robot of claim 35, wherein the cleaning robot is a snow clearing robot, and the cleaning device comprises a snow auger motor and a snow clearing bucket provided with snow auger blades.

37. The cleaning robot of claim 35, wherein the one or more sensors comprise at least one of a spatial positioning module configured to provide the position data, a wheel speed sensor configured to provide wheel rotation data as part of the operational data, a visual sensor configured to provide surface condition data as part of the operational data, a LiDAR sensor configured to provide surface profile data as part of the operational data, or a communication module configured to provide network signal data as part of the operational data.

38. The cleaning robot of claim 35, wherein the operations comprise:
when a plurality of priority regions are recorded during the first cleaning operation, determining a second-pass sequence by arranging the plurality of priority regions in an order according to a predefined arrangement rule based on the spatial coordinate data of each of the plurality of priority regions;
determining the second-pass route based on the second-pass sequence; and
controlling the drive assembly and the cleaning device to perform the second cleaning operation on the plurality of priority regions according to the second-pass route.

39. The cleaning robot of claim 38, wherein arranging the plurality of priority regions comprises determining, for each of the plurality of priority regions, an entry point and an exit point based on the spatial coordinate data of the priority regions and spatial coordinate data of a designated discharge location, the second-pass sequence including the entry point and the exit point of each of the plurality of priority regions.

40. The cleaning robot of claim 35, wherein the operations comprise storing, in the memory, an association between the spatial coordinate data of the priority region and a type of the detected predefined trigger condition.
